(19) United States
(12) Patent Application Publication
(10) Pub. No.: US 2018/0272450 A1
(43) Pub. Date: Sep. 27, 2018

(54) EDM DRILLING OF CERAMICS AND DEVICE

(71) Applicant: Siemens Aktiengesellschaft, München (DE)

(72) Inventors: Susanne Kamenzky, Berlin (DE); Jan Münzer, Berlin (DE); Dimitrios Thomaidis, Berlin (DE)

(21) Appl. No.: 15/765,047

(22) PCT Filed: Sep. 7, 2016
(86) PCT No.: PCT/EP2016/071082

§ 371 Date: Mar. 30, 2018

(30) Foreign Application Priority Data
Oct. 5, 2015 (DE) 10 2015 219 184.2

(51) Int. Cl. B23H 3/04; B23H 9/10; B23H 9/14; B23H 5/06

(52) U.S. Cl. CPC B23H 3/04; B23H 5/06; B23H 9/14; B23H 9/10

(57) ABSTRACT

Ceramics or ceramic layer systems can be machined due to the use of high speeds of an EDM electrode. Disclosed is a method and an EDM device for carrying out the method for drilling ceramics or ceramic-coated components, which uses an EDM electrode and wherein the EDM electrode is rotated at a speed of at least 1000 rpm, in particular of at least 10,000 rpm, for drilling through the ceramic or through the ceramic-coated component.

### CROSS-REFERENCE TO RELATED APPLICATIONS

This application claims priority to PCT Application No. PCT/EP2016/071082, having a filing date of Sep. 7, 2016, based off of German application No. 102015219184.2, having a filing date of Oct. 5, 2015, the entire contents of both of which are hereby incorporated by reference.

### FIELD OF TECHNOLOGY

The following relates to a method for drilling ceramics using EDM, and to a device.

### BACKGROUND

It is currently possible to use EDM to drill only metallic components, since ceramics are not electrically conductive.

### SUMMARY

An aspect relates to solving the aforementioned problem.

### BRIEF DESCRIPTION

Some of the embodiments will be described in detail, with reference to the following figures, wherein like designations denote like members, wherein:

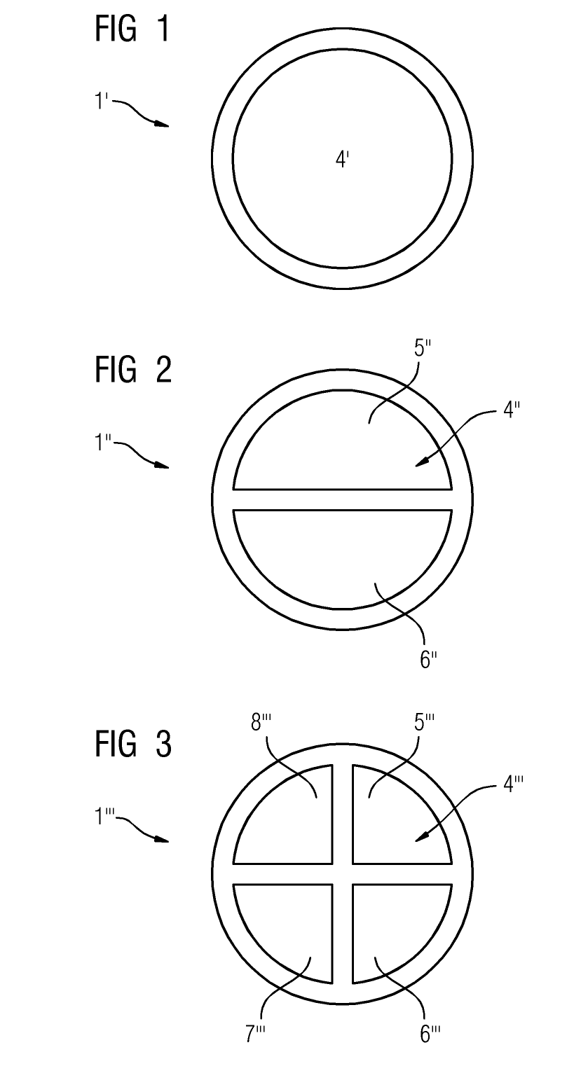

FIG. 1 shows an exemplary embodiments of EDM electrodes;

FIG. 2 shows a first embodiment of a multiple channel electrode; and

FIG. 3 shows a second embodiment of a multiple channel electrode.

### DETAILED DESCRIPTION

The figures and the description represent only exemplary embodiments of the invention.

The problem is solved by using high rotational speeds. The rotational speed is at least 1000 rpm, in particular at least 10,000 rpm and can even be as high as 30,000 rpm-50,000 rpm.

Instead of standard hollow electrodes 1′, which have just a single internal channel 4′ (FIG. 1), use is preferably made of multi-channel electrodes 1″, 1″' (FIG. 2, 3).

These electrodes 1′, 1″, 1″' (FIG. 1, 2, 3) are applied to a workpiece with higher rotational speed. In so doing, the web or webs of the internal channels 5″, 6″; 5″', 6″', 7″', 8″' (FIG. 2, 3) act as cutting edges and remove the ceramic layer. Once the ceramic layer has been drilled through, and the electrically conductive metal is exposed, the eroding process begins as is conventional with metallic materials.

In that context, the electrodes used for the removal of ceramic and those used for eroding can be the same.

It is also possible to use different electrodes for the removal of ceramic to those used for eroding the metal. This would make sense for machining time reasons, if a multi-channel electrode 1″, 1″' can machine the ceramic more rapidly and a single-channel electrode 1′ can erode more rapidly. In this case, it would be possible to first remove the ceramic from all of the ceramic-coated components, then exchange the electrode and then erode the cooling bores using the same EDM machine and without unclamping the component.

The inventive step lies in the fact that with the described method, that is to say a combination of a chip-removing and an eroding production method using a single tool, the eroding electrode, it is now possible, on one eroding machine and using the eroding electrode itself, to drill in a two-step method cooling air bores in a hot-gas-guiding component having a ceramic thermal barrier coating that is not electrically conductive. This makes for more economical processing since it is no longer necessary for the component, after metallic coating, to be drilled, masked and then coated with ceramic, but rather the component can be drilled in one processing step on one machine after complete coating. The quality of the machining result is also improved since the geometry of the bore can be carried out nearly in the region of the ceramic, while the masking process always gives rise to large discontinuities there, which can have a negative influence on cooling effect and the integrity of the layer bonding. Processing time is also reduced owing to the simplified technical sequences and the streamlined logistics.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for drilling ceramics or ceramic-coated components, which uses an EDM electrode and wherein the EDM electrode is rotated at a speed of at least 1000 rpm, for drilling through the ceramic or through the ceramic-coated component.

2. The method as claimed in claim 1, in which a liquid is routed through an interior of the EDM electrode, which liquid serves, during drilling through the ceramic, as a coolant and/or a transport medium for removed material, and during optional drilling through metal an electrolyte is routed through the interior of the EDM electrode.

3. The method as claimed in claim 1, in which a layer system of a ceramic layer and a metallic substrate is machined, in which first the ceramic is machined using higher rotational speeds of at least 1000 rpm, and then the metallic part of the layer system, wherein an electrolyte is then used, and in particular lower rotational speeds of strictly less than 1000 rpm are used.

4. An EDM device, for carrying out the method as claimed in claim 1 which has an EDM electrode, that can be rotated at speeds of 1000 rpm, in particular of at least 10,000 rpm.

5. The method as claimed in claim 1, in which the EDM electrode has multiple internal channels.

6. The method as claimed in claim 1, in which various types of EDM electrode are or can be used, for the machining of the ceramic and of the metal.
